(19) United States
(12) Patent Application Publication
(10) Pub. No.: US 2026/0292954 A1
(43) Pub. Date: Sep. 24, 2026

(54) METHOD AND SYSTEM WITH CONTROLLER FOR CONTROLLING LIGHTING DEVICES

(71) Applicant: SIGNIFY HOLDING B.V., EINDHOVEN (NL)

(72) Inventors: EVREN ÖZCAN, EINDHOVEN (NL); PETER DEIXLER, EINDHOVEN (NL)

(21) Appl. No.: 19/474,110

(22) PCT Filed: Mar. 29, 2024
(86) PCT No.: PCT/EP2024/058749

§ 371 Date: Oct. 9, 2025

Related U.S. Application Data
(60) Provisional application No. 63/458,262, filed on Apr. 10, 2023.

(30) Foreign Application Priority Data
Apr. 18, 2023 (EP) 23168378.0

(51) Int. Cl. H05B 45/58

(52) U.S. Cl. CPC H05B 45/58

(57) ABSTRACT

A system is disclosed, comprising a plurality of lighting devices and a controller configured to control operation of the respective ones of the plurality of lighting devices. Each lighting device is configured to store data indicative of at least one of one or more natural resources usage or one or more potential environmental impacts which is caused by operations carried out in relation to the lighting device from its manufacture and during the lifetime thereof. The controller is configured to control operation of at least one of the plurality of lighting devices based on measures of at least one resource usage and/or measures of at least one potential environmental impact for the respective ones of the lighting devices derived from the stored data of the respective ones of the lighting devices. A related method is also disclosed.

### TECHNICAL FIELD

The present invention relates to a system comprising a plurality of lighting devices and a controller configured to control operation of the respective ones of the plurality of lighting devices, wherein the controller is configured to control operation of at least one of the plurality of lighting devices based on a measure of resource usage and/or potential environmental impact associated with the lighting device. The present invention further relates to a related method.

### BACKGROUND

A light-generating system may include a plurality of light sources, or lighting devices, the operation of which may be controlled individually. Thereby, the light emission of each light source or lighting device in the system may controlled, for example by a controller or control device which may be included in the light-generating system. Such light sources or lighting devices may for example comprise or be constituted by one of more light-emitting diodes (LEDs).

### SUMMARY

Life Cycle Assessment (LCA) is a methodology that may be used to assess potential environmental impacts associated with the entire lifecycle of a product. The lifecycle of a product may include the following stages: (1) extraction of raw material needed for the product, (2) processing related to the making of the product (e.g., manufacturing), (3) shipping, or transportation, carried out in relation to the product, (4) use of the product by the user(s), and (5) disposal of the product at the end of its lifecycle. LCA may alternatively be referred to as Life Cycle Analysis. The stages of the lifecycle of a product may include the upstream (e.g., suppliers) and downstream (e.g., waste management) processes associated with the production (e.g., production of raw, auxiliary, and operating materials), use, and disposal (e.g., waste incineration) of the product. In order to assess potential environmental impacts associated with the entire lifecycle of a product, all relevant inputs from the environment (e.g., ores, crude oil, water, land use, etc.) as well as emissions into air, water and soil (e.g., carbon dioxide and nitrogen oxides) may be considered. The International Organization for Standardization provides guidelines and requirements for conducting an LCA according to ISO 14040 and ISO 14044.

LCA methodologies and possibly any similar methodologies may be used to assess potential environmental impacts associated with the entire lifecycle of a lighting device, e.g., a lighting device comprising or being constituted by one of more light-emitting diodes (LEDs). The inventors have realized that it would be desirable to take into account potential environmental impacts associated with lighting devices in operation of a system including such lighting devices, whereby potential environmental impacts which may be associated with one or more of the lighting devices of the system may be reduced.

In view of the above, a concern of the present invention is to provide means for facilitating or allowing for reducing any potential environmental impacts which may be associated with one or more lighting devices included in a system comprising a plurality of lighting devices.

To address at least one of this concern and other concerns, a system and a method in accordance with the independent claims are provided. Preferred embodiments are defined by the dependent claims.

The present invention is defined by the appended independent and dependent claims.

According to a first aspect, the invention provides a system comprising: a plurality of lighting devices; and a controller configured to control operation of the respective ones of the plurality of lighting devices; wherein each lighting device is configured to store data indicative of one or more natural resources usage, the data including an inventory table listing resource usage of the respective lighting device accumulated so far during the lifetime thereof; wherein the controller is configured to: obtaining the stored data for each of the lighting devices; determine, for each of the lighting devices, a value of at least one environmental impact of the lighting device derived from the stored data of the respective lighting device by applying a transformation function to said data indicative of the one or more natural resources usage; and control operation of at least one of the plurality of lighting devices based on the value of the at least one environmental impact determined for the respective ones of the lighting devices.

According to a first aspect, the invention provides a method in a system comprising a plurality of lighting devices, each lighting device configured to store data indicative of one or more natural resources usage, the data including an inventory table listing resource usage of the respective lighting device accumulated so far during the lifetime thereof; the method comprising: obtaining the stored data for each of the lighting devices; determining (101), for each of the lighting devices, a value of at least one environmental impact of the lighting device derived from the stored data of the respective lighting device by applying a transformation function to said data indicative of the one or more natural resources usage; and controlling (102) operation of at least one of the plurality of lighting devices based on the value of the at least one environmental impact determined for the respective ones of the lighting devices.

Said environmental impact may be phrased as potential environmental impact. The natural resource usage and resource usage may be phrased interchangeably.

In aspects, the (natural) resource usage comprises inputs and outputs related to a respective resource type, the resource type being for example at least one of water, fuel, copper, nickel, glue, plastic, metal, iron, aluminum, phosphor, paper or other packaging material. In aspects, the natural resource usage comprises physical and tangible resources.

According to an aspect, a system is provided. The system comprises a plurality of lighting devices and a controller. The controller is configured to control operation of the respective ones of the plurality of lighting devices. Each lighting device is configured to store (and optionally obtain) data indicative of at least one of one or more natural resources usage or one or more potential environmental impacts which is caused by operations carried out in relation to the lighting device from its manufacture and during the lifetime thereof. The controller is configured to determine, for each of the lighting devices, at least one of a measure of at least one resource usage or a measure of at least one potential environmental impact of the lighting device derived from (or derivable from, or based on) the stored data of the lighting device. The measure of the at least one potential environmental impact of the lighting device may be derived from the data indicative of one or more natural resources usage. The controller is configured to control operation of at least one of the plurality of lighting devices based on the measures of the at least one resource usage and/or the measures of the at least one potential environmental impact determined for the respective ones of the lighting devices.

According to an aspect, a method in a system is provided. The system comprises a plurality of lighting devices. Each lighting device is configured to store (and optionally obtain) data indicative of at least one of one or more natural resources usage or one or more potential environmental impacts which is caused by operations carried out in relation to the lighting device from its manufacture and during the lifetime thereof. The method comprises determining, for each of the lighting devices, at least one of a measure of at least one resource usage or a measure of at least one potential environmental impact of the lighting device derived from (or derivable from, or based on) the stored data of the lighting device. The method comprises controlling operation of at least one of the plurality of lighting devices based on the measures of the at least one resource usage and/or the measures of the at least one potential environmental impact determined for the respective ones of the lighting devices.

According to an aspect, a computer program product is provided. The computer program product comprises instructions which, when executed by one or more processors of a controller of a system according to the first aspect, cause the controller to carry out a method according to the second aspect.

The measures of at least one resource usage and the measures of the at least one potential environmental impact determined for the respective ones of the lighting devices may for example be values representative of the at least one resource usage and the at least one potential environmental impact, respectively. The larger the measure or value of at least one potential environmental impact of a lighting device, the larger the at least one potential environmental impact of the lighting device may be. Thus, if comparing two lighting devices having different measures or values of at least one potential environmental impact, the lighting device having the largest measure or value of at least one potential environmental impact may be considered to be the less environmentally sustainable lighting device of the two lighting devices.

By each of the lighting device being configured to store (and optionally obtain) data indicative of at least one of one or more natural resources usage or one or more potential environmental impacts which is caused by operations carried out in relation to the lighting device from its manufacture and during the lifetime thereof, and by controlling operation of at least one of the plurality of lighting devices based on the measures of the at least one resource usage and/or the measures of the at least one potential environmental impact determined for the respective ones of the lighting devices, the operation of the plurality of lighting devices may be controlled in dependence on the (e.g., estimated) environmental impact of the respective lighting devices. This allows for a new realm of lighting device control. For example, it allows for a control scheme in which operation of the lighting device(s) of the system considered to be environmentally sustainable are operated may be prioritized over operation of any lighting device of the system not considered to be environmentally sustainable, or at least less environmentally sustainable. For example, in case two lighting devices of the lighting system are able to provide a particular lighting functionality (e.g., ambient lighting) and a first of the two lighting devices is considered to be environmentally sustainable but the second is not (or if the second lighting device has a measure or value of at least one potential environmental impact that is larger than that of the first lighting device), the first lighting device may be operated to render the lighting functionality, but not the second lighting device. Another example application is streetlighting. Turning on streetlights may be triggered by presence detection, such that if presence of one or more persons in the vicinity of a group of streetlights is detected, the streetlights are turned on so as to emit light. However, if the function of turning on the light can sufficiently be achieved by one streetlight within the group of streetlights, only the streetlight considered to be environmentally sustainable of the group of streetlights may be turned on. According to another example, operation of the lighting devices may be controlled based on a property of resource usage. For example, in case each of the lighting devices of the system is able to provide a relatively energy-demanding lighting functionality (e.g., entertainment lighting), only the lighting device(s) of the system for which the measure or value of the at least one resource usage is not exceeding a (e.g., predefined) threshold (value) may be operated to provide that lighting functionality. The other one(s) of the lighting devices of the system may not be operated to provide that lighting functionality, as it already may have a relatively high resource usage (e.g., energy) so far (during its lifetime), as indicated by the measure or value of the at least one resource usage thereof exceeding the (predefined) threshold (value). According to another example, operation of the lighting device(s) of the system considered to be environmentally unsustainable, or at least less environmentally sustainable, than other lighting device(s) of the system may be prioritized over operation of the other lighting device(s) of the system. This may for example be done in order to reduce the lifetime of the lighting device(s) of the system considered to be environmentally unsustainable, or at least less environmentally sustainable, by controlling that or those lighting devices to carry out highly electronics-reliability-degrading lighting tasks while sparing the other lighting device(s) of the system from having to carry out such tasks. An example is starting up streetlights during (e.g., extremely) cold weather conditions. It may as an example be assumed that the system includes, e.g., six lighting devices (e.g., streetlights), and that a minimum of three lighting devices are required to be operated in order to meet any lighting regulations. Then, the three lighting devices of the system which are less environmentally sustainable than the other three lighting devices of the system may be controlled to be started up while the other lighting devices are spared from having to be started up during such cold weather conditions. Thereby, the electronics of the three lighting devices of the system which are less environmentally sustainable than the other three lighting devices of the system will degrade faster than the electronics of the other lighting devices, which may lead to earlier failure of the three lighting devices of the system which are less environmentally sustainable than the other three lighting devices, as compared to the other lighting devices.

The lighting device control may be carried out under one or more constraints, which for example may represent what type of control behavior is acceptable to a user of the system. For example, the system may comprise two lighting devices of the same type, e.g., two identical Hue lamps, which for example may be located in a home. The user may set a constraint (e.g., in the controller) that one of the two lighting devices is to be used to provide decorative lighting, with the light emitted having a relatively low brightness, constantly during the night (i.e., not depending on whether presence is detected or not), while the other one of the lighting devices is to be used to provide a relatively high luminous flux at a specific location (e.g., in a hallway, to provide functional lighting), which may be activated only if presence is detected.

Each or any of the lighting devices may be configured to obtain and store data indicative of at least one of one or more natural resources usage or one or more potential environmental impacts which is caused by operations carried out in relation to the lighting device from its manufacture and during the lifetime thereof repeatedly at different time instants, wherein the obtained data may be added to any existing stored data or may be used to update or maintain any existing stored data. Thus, each or any of the lighting devices may be configured to store and additionally actively maintain the data.

For each or any of the plurality of lighting devices, the measure of at least one potential environmental impact of the lighting device may be derived from data indicative of one or more natural resources usage in the stored data of the lighting device by means of an LCA method. In alternative or in addition, it is contemplated that the measure of at least one potential environmental impact of the lighting device could be derived from data indicative of one or more natural resources usage in the stored data of the lighting device by means of any methodology similar to LCA methodologies. Thus, even if one or more embodiments disclosed herein are described with reference to (e.g., utilization of) an LCA method or LCA methodology, it is to be understood that such embodiment(s) could additionally or in alternative utilize any other method or methodology similar to LCA methods and methodologies. The measure or value of at least one potential environmental impact of the respective ones of the lighting devices could for example be derived from applying a transformation, e.g., a transformation function, to the data indicative of one or more natural resources usage in the stored data of the lighting device. Such a transformation or transformation function may be predefined, and may for example depend on an LCA methodology that may be used. Thus, the transformation or transformation function may be defined by, or as part of, an LCA methodology that may be used. The transformation or transformation function may be stored in the controller, e.g., in a memory thereof. The transformation or transformation function may for example be in accordance with the guidelines and requirements for conducting an LCA of the International Organization for Standardization according to ISO 14040 and ISO 14044. Said transformation function may for example multiply data indicative of one or more natural resources usage in the stored data of the lighting device with a respective characterization factor. Such characterization factors may for example be derived from the ILCD International Life Cycle Data system of the European Platform on LCA (EPLCA) of the European Commission. See, e.g., the ILCD handbook (ISBN 978-92-79-19092-6; doi: 10.2788/38479).

For each or any of the plurality of lighting devices, the data indicative of at least one of one or more natural resources usage or one or more potential environmental impacts which is caused by operations carried out in relation to the lighting device from its manufacture and during the lifetime thereof may for example relate to at least one of manufacturing, shipping, storage, installation, use or disposal of the lighting device. The data may be obtained from different entities involved in operations carried out in relation to the lighting device from its manufacture and during the lifetime thereof, such as different entities involved in the manufacturing, shipping, storage, installation, use and/or disposal of the lighting device. In the context of the present application, disposal of a lighting device may mean or involve recycling and/or refurbishing of the lighting device. The data relating to manufacturing of the lighting device may include data relating to or indicating the use of natural resources needed to manufacture the lighting device. The data relating to installation of the lighting device may include data indicative of one or more potential environmental impacts which is caused by external conditions during the installation of the lighting device. For example, if the lighting device is a streetlight installed in a tunnel, and if, as a result of the installation of the streetlight, a traffic jam on the roads through and in the vicinity of the tunnel occurred, this could result in an environmental impact, and may hence be indicated in the data.

For each or any of the plurality of lighting devices, the data indicative of at least one of one or more natural resources usage or one or more potential environmental impacts which is caused by operations carried out in relation to the lighting device from its manufacture and during the lifetime thereof may for example comprise or be constituted by LCA data. LCA data may for example be provided in an ‘LCA data file’. The LCA data or LCA data file may be associated with a Life Cycle Inventory of the lighting device, which Life Cycle Inventory may be in accordance with or based on LCA methodologies. The LCA data or LCA data file may include data on (e.g., a list) of one or more (e.g., natural) resources usage which is caused by operations carried out in relation to the lighting device from its manufacture and during the lifetime thereof so far, i.e., up to the current point in the lifetime of the lighting device. Such data or list may be referred to as an inventory, or inventory data or inventory table. In accordance with LCA methodologies, the potential environmental impact(s) may be determined (e.g., calculated) based on the one or more resources usage (e.g., based on the inventory table). While one or more embodiments disclosed herein are described with reference to “LCA data” or “LCA data file”, it is to be understood that this does not necessarily limit the disclosed embodiments to LCA methods and methodologies; rather the disclosed embodiment(s) could additionally or in alternative utilize any other method or methodology similar to LCA methods and methodologies. In the context of the present application, the expressions “data indicative of at least one of one or more natural resources usage or one or more potential environmental impacts which is caused by operations carried out in relation to the lighting device from its manufacture and during the lifetime thereof”, “LCA data”, “LCA data file”, etc., can be used interchangeably without any loss of generality.

LCA methodologies may consider environmental impact during entire life cycle of a product (e.g., a product such as a lighting device), which may involve one or more of the following stages related to the product: (1) raw material extraction, (2) processing (e.g., manufacturing), (3) transportation, (4) use, and (5) disposal at the end of life of the lighting device. As indicated in the foregoing, LCA methodologies may use a Life Cycle Inventory. A Life Cycle Inventory includes data related to the product, which data quantifies all relevant inputs and outputs of the product during the above-mentioned stages. Such data is often estimated.

Each or any of the lighting devices may be configured to store (e.g., in a memory of the lighting device) data, e.g., in the form of an ‘LCA data file’, associated with the Life Cycle Inventory. For each or any of the lighting devices, the data may be updated during the various stages of an LCA, and the lighting device may be configured such that the data can be accessed or retrieved, e.g., by a user, at any given moment in time, for example at the end of life of the lighting device, or at a point in time when second-hand selling the lighting device. When accessed or retrieved, the data provides the inventory data accumulated so far, which can subsequently be transformed (e.g., using a standardized algorithm according to an LCA method) to a measure of a potential environmental impact (for various impact categories). This may render an accurate account of the environmental impact of each individual lighting device.

The LCA data file for a lighting device may essentially include a table that lists the resource usage during any of the different stages (1) to (5) as mentioned in the foregoing. The LCA data file may include several fields, each of which may include the input or output related to a certain resource type. The resource type may be selected accordingly.

The resource type may for example be power, electrical energy, water, fuel, copper, nickel, glue, plastic, metal, iron, aluminum, phosphor, paper or other packaging material, fossil fuel, etc. An LCA for a lighting device is often done theoretically. The data representing the inputs and outputs during each stage of the life cycle for the lighting device for establishing a Life Cycle Inventory may be estimated based on averages, especially for the use stage. For example, theoretically, a 17 W light bulb may operate at 1000 lumen on average for 3 hours each day. However, due to the current capabilities of ‘smart’ light bulbs, the exact use of light bulbs during the day may vary significantly. For example, the same light bulb may operate for 8 hours each day at low power consumption with a motion sensor; and can be dimmed, e.g., to ‘entertainment mode’ for 2 hours each evening; and may at days when the user studies emit bright functional light at maximum intensity for as long the studies lasts. Even though the light bulb is the same, the environmental impact can be different at each moment in time from the use stage to the end of life of the light bulb. For example, even comparing lamps being of the same type, one lamp can have had a larger environmental impact compared to another lamp. A particular lamp can if it has anti-burglar functionality installed have a larger environmental impact than if it does not have that functionality installed.

In view of the above, it may be beneficial to store and/or update the LCA data file of a lighting device during the operation of the lighting device, with the data for example being locally stored in the lighting device. For example, at the end of life of the lighting device, the data stored in the lighting device can thereby be retrieved (for example, when the lighting device is left at a disposal location or recycled or refurbished). Thus, an accurate environmental impact of the lighting device for the duration of its life cycle can be determined (e.g., calculated). The data stored in the lighting device can be retrieved to obtain the inventory data. Subsequently, the inventory data may be characterized into a common unit of a measure of at least one potential environmental impact of the lighting device, such as, for example, carbon dioxide equivalent, or some other common unit. The measure may represent the environmental issue(s) of concern to which the Life Cycle Inventory analysis results may be assigned. The at least one potential environmental impact may for example includes or be constituted by one or more of global warming potential (e.g., expressed in carbon dioxide equivalent) or natural resources depletion.

As mentioned, for each or any of the plurality of lighting devices, the measure of at least one potential environmental impact of the lighting device may be derived from data indicative of one or more natural resources usage in the stored data of the lighting device by means of applying a transformation, e.g., a transformation function, to the data indicative of one or more natural resources usage in the stored data of the lighting device. The transformation or transformation function may be predefined, and may for example depend on an LCA methodology that may be used. For example, there are many greenhouse gases being emitted (e.g., resources). Creating a list of the greenhouse gases emitted can provide the resource usage (e.g., inventory table). Using the LCA methodology, a carbon dioxide equivalent of each greenhouse gas (i.e., heat absorbed by greenhouse gas as a multiple of the heat that would be absorbed by the same mass of carbon dioxide) may be determined. The total carbon dioxide equivalent may then be used to express an environmental impact measure or value, e.g., a global warming potential. This may be similarly done for other environmental impacts, e.g., fossil fuel usage.

As mentioned, each or any of the lighting devices may be configured to store and additionally actively maintain the data (e.g., inventory data of an LCA). Data may be obtained and added to any existing stored data or may be used to update or maintain any existing stored data at or during any of the different stages (1) to (5) as mentioned in the foregoing, especially at or during any of the stages (1) to (4).

For example, at stages (1) and (2), data, e.g., in the form of the LCA data file, may be uploaded to the lighting device (e.g., to a memory thereof) during the production stage of the lighting device, or optionally at the start of the use of the lighting device. The data, e.g., the LCA data file, will then represent the resource usage (inputs and outputs) related to the raw material extraction stage, and the processing (e.g., manufacturing) stage. The resources required during the raw material extraction and processing stages of the lighting device are generally known by the manufacturer. Hence, the manufacturer may store a pre-filled LCA data file with the inventory data for the stages (1) and (2) in the lighting device or may update the inventory data of an existing (e.g., empty) LCA data file already present in the lighting device. This may occur at the end of the processing stage (e.g., when the lighting device is leaving the factory). According to another example, the inventory data related to the raw materials extraction and processing stages may be stored, or updated, by a network entity such as backend server of the manufacturer, for example if and when the lighting device becomes connected to the network entity for the first time. The lighting device may be associated with a unique identifier that may enable the network entity such as the backend server to transmit the corresponding data to the lighting device (e.g., similarly to a firmware update).

For example, at stage (3), the lighting device may subsequently be distributed and transported to a customer. For example at installation of the lighting device, the LCA data file may be updated with the resource usage during the transportation phase, which updating may depend on for example whether the lighting device is distributed by means of e-truck or a gasoline truck, whether the lighting device is transported by train or by ship, what happens to the packaging of the lighting device after its installation, whether additional resources are required to install the lighting device (e.g., glue, aluminum rails, etc.) or not, etc. The resource usage during installation may be estimated or may be actively monitored by, e.g., a person that installs the lighting device, in which case that person may update the LCA data file in the lighting device accordingly. For example, the lighting device may transmit its serial number and/or geographical location to a network entity such as a backend server of the manufacturer, and the network entity may return the resource usage during transportation known for the serial number and/or and optionally an estimated resource usage during transportation between the last known location of the lighting device (e.g., distribution center) and the geographical location of the lighting device. According to another example, the person that installs the lighting device may update the LCA data file with the resource usage during the transportation phase. The person that installs the lighting device may thereby have a predefined estimation of the resource usage during the transportation phase. Possibly, the manufacturer may provide the person that installs the lighting device with a questionary to fill in, such that the resource usage during the transportation stage can be accounted for and automatically calculated by estimation. The questions in the questionary may for example relate to the distance driven to the deliver the lighting device to its recipient, whether the vehicle used for delivering the lighting device is electrically powered, etc. Possibly, a part of the resource usage during the transportation stage may be retrieved from a tracking database of any distributors which may be used, such as DHL or United Parcel Service (UPS).

For example, during stage (4), i.e., during the use stage, the data file stored in the lighting device may be continuously updated. The data obtained during the use stage may be dominated by the energy consumption (fossil or green) of the lighting device. The lighting device may be able to measure its own energy usage.

Each or any of the lighting devices may be configured such that the data stored in the lighting device may be accessed or retrieved at any time, e.g., by an owner of the lighting device in the use stage, or by a manufacturer of the lighting device in the raw material extraction and/or processing stages.

The controller may be configured to obtain, for each of the lighting device, information on whether the lighting device is currently powered by electrical energy based on renewable energy sources or by electrical energy based on non-renewable energy sources. For example, an entity which may update the LCA data file of each or any of the lighting devices, e.g., during the use stage, may have access to such information, and may include the information in the LCA data file of the lighting device(s). In that way, a more accurate environmental impact may be determined when converting the LCA (inventory) data into an environmental impact. For example, consumption of energy derived from solar or wind based energy sources may have a different impact on global warming potential and/or abiotic resource depletion that consumption of energy from coal or gas based energy sources.

As mentioned, according to the first and second aspects of the invention, for each of the lighting devices, at least one of a measure of at least one resource usage or a measure of at least one potential environmental impact of the lighting device derived from the stored data of the lighting device is determined (e.g., by the controller), and then, operation of at least one of the plurality of lighting devices is controlled (e.g., by the controller) based on the measures of the at least one resource usage and/or the measures of the at least one potential environmental impact determined for the respective ones of the lighting devices. Thus, according to one or more embodiments of the present invention, the operation of the plurality of lighting devices can be controlled in dependence on the (e.g., estimated) environmental impact of the respective lighting devices, as determined by means of one or more LCA methodologies.

The plurality of lighting devices may be controlled (e.g., by the controller) such that any of the plurality of lighting devices having a value representative of the at least one resource usage and/or the at least one potential environmental impact that exceeds a threshold value is not operated and such that the other one(s) of the plurality of lighting devices are operated. The threshold value may represent a value of a measure of at least one resource usage and/or at least one potential environmental impact of the lighting devices chosen such that if the value is exceeded for a lighting device, the lighting devices is not considered to be environmentally sustainable. The other one(s) of the plurality of lighting devices may be controlled as a group, such that operation of each of the other one(s) of the plurality of lighting devices is controlled in the same way. In the context of the present application, by controlling lighting devices in the same way, it may be meant that the lighting devices are operated to provide the same lighting function or functionality, for example such that lighting devices in the form of Hue lamps provide the same function of ambient lighting. Further, by controlling lighting devices in the same way, it may be meant that each of the lighting devices is controlled so as to achieve the same or substantially the same overall light effect (which may be referred to as a light scene). Therefore, to control lighting devices in the same way may not necessarily entail that all lighting devices are controlled so as to emit light having the same characteristics such as intensity, color, dynamics, etc. (but it could be). The lighting devices could be controlled to emit light having different characteristics while still achieving the same or substantially the same overall light effect. For example, in entertainment lighting, different lamps may be caused to emit light with different characteristics based on the spatial positions of the lamps, but the overall effect may be the same (e.g., a sunset scene).

Each or any of the plurality of lighting devices may be configured to, when operated, selectively provide one or more lighting functionalities. The plurality of lighting devices may be controlled (e.g., by the controller) such that only any of the plurality of lighting devices having a value representative of the at least one resource usage and/or the at least one potential environmental impact that does not exceed a threshold value is operated to provide one or more of the lighting functionalities of the lighting devices. Thereby, the other one(s) of the plurality of lighting devices having a value representative of the at least one resource usage and/or the at least one potential environmental impact that exceeds a threshold value may not be operated to provide one or more of the lighting functionalities of the lighting devices. As before, the threshold value may represent a value of a measure of at least one resource usage and/or at least one potential environmental impact of the lighting devices chosen such that if the value is exceeded for a lighting device, the lighting devices is not considered to be environmentally sustainable. In that way, a user of the plurality of lighting devices may be encouraged to not utilize any one of lighting devices that is not considered to be environmentally sustainable, by that lighting device being unable to provide one or more of the lighting functionalities.

As mentioned, each or any of the lighting devices may be configured to, when operated, selectively provide one or more lighting functionalities. An average value or a sum of the values representative of the at least one resource usage and/or the at least one potential environmental impact determined for the respective ones of the lighting devices may be determined (e.g., by the controller). The plurality of lighting devices may be controlled (e.g., by the controller) such that they are not operated, or such that one or more selected lighting functionalities of the lighting devices are prevented from being used during operation of the lighting devices, or such that one or more selected lighting functionalities of the lighting devices are degraded during operation of the lighting devices, if the average value or sum exceeds a threshold value. As before, the threshold value may represent a value of a measure of at least one resource usage and/or at least one potential environmental impact of the lighting devices chosen such that if the value is exceeded for a lighting device, the lighting devices is not considered to be environmentally sustainable.

By controlling the plurality of lighting devices such that they are not operated if the average value or sum exceeds the threshold value, the plurality of lighting devices may not be grouped with any other additional lighting devices (which may or may not be included in the system and which may be considered to be environmentally sustainable). In this way, it may be achieved that for a grouping of lighting devices, none of the lighting devices of the group which are considered to be environmentally sustainable are operated, or such that lighting devices considered to be (e.g., highly) environmentally sustainable will not be grouped with lighting devices considered to be (e.g., significantly) less environmentally sustainable.

By controlling the plurality of lighting devices such that such that one or more selected lighting functionalities of the lighting devices are degraded or even prevented from being used during operation of the lighting devices if the average value or sum exceeds the threshold value, a user of the plurality of lighting devices may be encouraged to not utilize a group of the lighting devices (i.e., the plurality of lighting devices) if the group of the lighting devices is not an environmentally sustainable group of lighting devices. For example, the maximum intensity of the light emitted by the respective ones of the lighting devices and/or operating power of the respective ones of the lighting devices may be restricted if the average value or sum exceeds the threshold value.

An average value or a sum of the values representative of the at least one resource usage and/or the at least one potential environmental impact which have been determined for the respective ones of the lighting devices may be determined (e.g., by the controller). If the average value or sum does not exceed a threshold value, the plurality of lighting devices may be controlled (e.g., by the controller) as a group, such that operation of each of the plurality of lighting devices is controlled in the same way. If the average value or sum exceeds the threshold value, the plurality of lighting devices may be controlled (e.g., by the controller) individually, and not as a group. In this way, it may be achieved that only if the plurality of lighting devices, as a group, are considered to environmentally sustainable, they are controlled as a group—in the same way—and otherwise each of the plurality of lighting devices is be controlled individually. This may ensure that only lighting devices considered to environmentally sustainable can be controlled in a group, or that the group of lighting devices itself meets a requirement for environmental sustainability, or to encourage environmentally unsustainable lighting devices to not be controlled as a group. As before, the threshold value may represent a value of a measure of at least one resource usage and/or at least one potential environmental impact of the lighting devices chosen such that if the value is exceeded for a lighting device, the lighting devices is not considered to be environmentally sustainable.

For each of the lighting device, information on whether the lighting device is currently powered by electrical energy based on renewable energy sources (which may be referred to a ‘green energy’) or by electrical energy based on non-renewable energy sources (which may be referred to a ‘grey energy’) may be obtained. Such information may for example be obtained by the controller. Accordingly, the controller may be configured to obtain such information. The plurality of lighting devices may be controlled (e.g., by the controller) such that any lighting device(s) having a value representative of the at least one resource usage and/or the at least one potential environmental impact that is exceeding a threshold value is operated only if the lighting device(s) is currently powered by electrical energy based on renewable energy sources, and such that any lighting device(s) having a value representative of the at least one resource usage and/or the at least one potential environmental impact that is not exceeding the threshold value is operated if the lighting device(s) is currently powered by electrical energy based on non-renewable energy sources. As before, the threshold value may represent a value of a measure of at least one resource usage and/or at least one potential environmental impact of the lighting devices chosen such that if the value is exceeded for a lighting device, the lighting devices is not considered to be environmentally sustainable. In this way, lighting device(s) considered to be environmentally sustainable may be operated (e.g., only) if it is currently powered by electrical energy based on non-renewable energy sources, and lighting device(s) considered to environmentally unsustainable (or at least less environmentally sustainable) may be operated (e.g., only) if it is currently powered by electrical energy based on renewable energy sources. In that way, less environmentally sustainable lighting devices and more environmentally sustainable lighting devices can be brought closer together with respect to their environmental impact.

According to one implementation example, the controller may for each of the plurality of lighting devices determine whether the lighting device is currently powered by green energy or by grey energy, and control only that or those lighting devices having a measure or value of at least one potential environmental impact that is not exceeding a threshold (value) to provide a lighting functionality if it or they are currently powered by grey energy, and control only that or those lighting devices having a measure or value of at least one potential environmental impact that is exceeding a (or the) threshold (value) to provide a lighting functionality if it or they are currently powered by green energy. Thereby, less environmentally sustainable lighting devices and more environmentally sustainable lighting devices can be brought closer together with respect to their environmental impact.

The controller may be configured to obtain, for each of the lighting device, a value representative of an emission intensity of the electrical energy by which the lighting device is currently powered. The value representative of an emission intensity of the electrical energy by which the lighting device is currently powered may for example be a value representative of carbon intensity of the electrical energy by which the lighting device is currently powered, and may for example be constituted by the carbon intensity per kilowatt-hour or some similar quantity. The controller may for example be configured to obtain (e.g., receive or retrieve) the value representative of an emission intensity of the electrical energy by which the lighting device is currently powered from some entity which provides estimations of the emission intensity (e.g., carbon intensity) of electricity consumed in an electrical power system across different regions of the country in which the lighting device is used. The controller may be configured to control the plurality of lighting devices such that any lighting device(s) having a value representative of the at least one resource usage and/or the at least one potential environmental impact that is exceeding a threshold value is operated only if the value of the emission intensity of the electrical energy by which the lighting device(s) is currently powered is not exceeding a threshold emission intensity value, and such that any lighting device(s) having a value representative of the at least one resource usage and/or the at least one potential environmental impact that is not exceeding the threshold value is operated if the value of the emission intensity of the electrical energy by which the lighting device(s) is currently powered exceeds the threshold emission intensity value. As before, the threshold value may represent a value of a measure of at least one resource usage and/or at least one potential environmental impact of the lighting devices chosen such that if the value is exceeded for a lighting device, the lighting devices is not considered to be environmentally sustainable.

As mentioned, for each of the lighting devices, at least one of a measure of at least one resource usage or a measure of at least one potential environmental impact of the lighting device derived from the stored data of the lighting device may be determined (e.g., by the controller). The determination of the (currently accrued) measure of at least one potential environmental impact of the lighting devices may be done in several ways.

For example, for each of the lighting devices, a measure of the at least one potential environmental impact of the lighting device may for example be determined (e.g., by the controller) in the following way. For each of the lighting devices, the stored data of the lighting device may be obtained (e.g., received or retrieved), and the measure of the at least one potential environmental impact of the lighting device may be determined based on data indicative of one or more natural resources usage in the stored data of the lighting device. Thus, according to one example, the controller may obtain the stored data (e.g., including an inventory table with a list of resource usage) from each of the lighting devices, and then determine (e.g., calculate) the measure of the at least one potential environmental impact of the lighting device based on the data.

Thus, according to one implementation example, the controller may obtain (or read, determine, or poll) the stored data file of each lighting device of the plurality of lighting devices. As mentioned, the data file may be indicative of the resource usage related to the lighting device during the respective stages of the lifecycle of the lighting device, and the data file may comprise a list of resources and a plurality of entries, each defining a resource usage of a listed resource during a lifecycle of the lighting device. The controller may then transform the resource usage of the lighting device during the respective stages of the lifecycle of the lighting device into a measure of at least one potential environmental impact of the lighting device (e.g., based on LCA methodologies). In this way, it may for example be determined that a first lighting device of the plurality of lighting devices has a Global Warming Potential X, a second lighting device of the plurality of lighting devices has a Global Warming Potential Y, a third lighting device of the plurality of lighting devices has a Global Warming Potential Z, etc., where X, Y, and Z may be values representative of global warming potential.

In alternative or in addition, the measure of the at least one potential environmental impact of each of the lighting devices may be determined by the respective ones of the lighting devices. Each lighting device may be configured to determine a measure of the at least one potential environmental impact of the lighting device based on data indicative of one or more natural resources usage in the stored data of the lighting device.

The controller may be configured to determine, for each of the lighting devices, a measure of the at least one potential environmental impact of the lighting device by, for each of the lighting devices, obtaining (e.g., receiving or retrieving) the measure of the at least one potential environmental impact of the lighting device having been determined by the lighting device.

Thus, according to one implementation example, the stored data file of each lighting device of the plurality of lighting devices may be indicative of the resource usage related to the lighting device during the respective stages of the lifecycle of the lighting device, and the data file may comprise a list of resources and a plurality of entries, each defining a resource usage of a listed resource during a respective stage of the lifecycle of the lighting device. Each of the plurality of lighting devices may transform the resource usage of the lighting device during the respective stages of the lifecycle of the lighting device into a measure of at least one potential environmental impact of the lighting device (e.g., based on LCA methodologies). The controller may then, for each of the plurality of lighting devices, obtain (or read, or determine) the measure of the at least one potential environmental impact of the lighting device having already been determined ‘locally’by the lighting device.

For each of the plurality of lighting devices, the measure of the at least one potential environmental impact of each of the lighting device may be determined (e.g., by the controller or by the lighting device itself) based on data indicative of one or more natural resources usage in the stored data of the lighting device for example by means of an LCA method.

The at least one potential environmental impact may for example include or be constituted by one or more of global warming potential or natural resources depletion, such as abiotic depletion.

The controller may for example comprise a user interface or be constituted by a user interface device. The controller may be configured to obtain (e.g., receive or retrieve) an indication of a threshold value such as described in the foregoing. For example, any user interface of the controller may be configured to receive user input indicating the threshold value.

According to one or more other example embodiments of the present invention, the system may comprise a user interface device, which may comprise the controller and some means for providing information or indications to a user, e.g., a display to provide visual indications or feedback. Means for providing other types of indications or feedback, such as audible, are however possible. The measures of at least one resource usage and/or the measures of at least one potential environmental impact of the lighting device derived from the stored data of the respective ones of the lighting devices, e.g., the values representative of the at least one resource usage and/or the at least one potential environmental impact, respectively, may be presented to the user via the display. The controller may be configured to determine a suggestion to the user for how to control the plurality of lighting devices based on the determined measures or values and indicate the suggestion to the user via the display. For example, if any of the determined measures or values exceeds a predefined threshold (value), the controller may be configured to generate an alert to the user, e.g., a visual alert via the display, and/or a suggestion to the user for how to control the plurality of lighting devices. The controller may be configured to aggregate the determined measures or values and indicate an aggregated measure or value of at least one potential environmental impact to the user via the display.

The controller may be connected with each of the plurality of lighting devices. For example, each or any of the plurality of lighting devices may comprise a processor that is configured to store (and optionally obtain) the data. In aspects, a master lighting device of the plurality of lighting devices may comprise the controller. For each or any of the plurality of lighting devices, the data may for example be stored in the lighting device, such as, for example, in a memory which may be comprised in the lighting device. In alternative or in addition, for each or any of the plurality of lighting devices, the data could be stored in some other entity accessible by the lighting device and/or the controller, e.g., in an entity included in a communications network which the lighting device(s) and/or the controller may be connected to.

Each or any of the plurality of lighting devices may for example comprise or be constituted by one of more LEDs.

The controller may for example comprise one or more processors, control units, control devices, etc., each or any of which for example may include or be constituted by any suitable central processing unit (CPU), microcontroller, digital signal processor (DSP), Application Specific Integrated Circuit (ASIC), Field Programmable Gate Array (FPGA), etc., or any combination thereof. The controller or one or more control units, control devices, etc., may optionally be capable of executing software instructions stored in a computer program product, e.g., in the form of a memory. The memory may for example be any combination of read and write memory (RAM) and read only memory (ROM). The memory may comprise persistent storage, which for example can be a magnetic memory, an optical memory, a solid state memory or a remotely mounted memory, or any combination thereof.

The controller or one or more control units, control devices, etc., may for example comprise driver circuitry (e.g., LED driving circuitry) for controlling supply of power to the respective ones of the lighting devices and/or for controlling operation of the respective ones of the lighting devices. The driver circuitry may for example comprise driver circuitry configured to drive (or control operation of) the respective ones of the lighting device. The controller or one or more controllers, control units, control devices, etc., may be configured to control operation of the respective ones of the lighting devices for example by way of transmitting at least one control signal or control message or the like to the respective ones of the lighting devices.

In aspects, the invention may provide a system comprising: a plurality of electronic devices; and a controller configured to control operation of the respective ones of the plurality of electronic devices; each electronic device being configured to obtain and store data indicative of at least one of one or more natural resources usage or one or more potential environmental impacts which is caused by operations carried out in relation to the electronic device from its manufacture and during the lifetime thereof; the controller being configured to: determine, for each of the electronic devices, at least one of a measure of at least one resource usage or a measure of at least one potential environmental impact of the electronic device derived from the stored data of the electronic device; and control operation of at least one of the plurality of electronic devices based on the measures of the at least one resource usage and/or the measures of the at least one potential environmental impact determined for the respective ones of the electronic devices. Thus, principles of one or more embodiments of the present invention may be applicable not only to systems comprising a plurality of lighting devices, but may apply similarly or the same as described herein to systems comprising one or more types of electronic devices other than lighting devices.

Further objects and advantages of the present invention are described in the following by means of exemplifying embodiments. It is noted that the present invention relates to all possible combinations of features recited in the claims. Further features of, and advantages with, the present invention will become apparent when studying the appended claims and the description herein. Those skilled in the art realize that different features of the present invention can be combined to create embodiments other than those described herein.

### BRIEF DESCRIPTION OF THE DRAWINGS

Exemplifying embodiments of the invention will be described below with reference to the accompanying drawings.

FIG. 1 is a schematic view of a system according to an embodiment of the present invention.

FIG. 2 is a schematic flowchart of a method according to an embodiment of the present invention.

All the figures are schematic, not necessarily to scale, and generally only show parts which are necessary in order to elucidate embodiments of the present invention, wherein other parts may be omitted or merely suggested.

### DESCRIPTION WITH REFERENCE TO THE DRAWINGS

The present invention will now be described hereinafter with reference to the accompanying drawings, in which exemplifying embodiments of the present invention are shown. The present invention may, however, be embodied in many different forms and should not be construed as limited to the embodiments of the present invention set forth herein; rather, these embodiments of the present invention are provided by way of example so that this disclosure will convey the scope of the invention to those skilled in the art. In the drawings, identical reference numerals denote the same or similar components having a same or similar function, unless specifically stated otherwise.

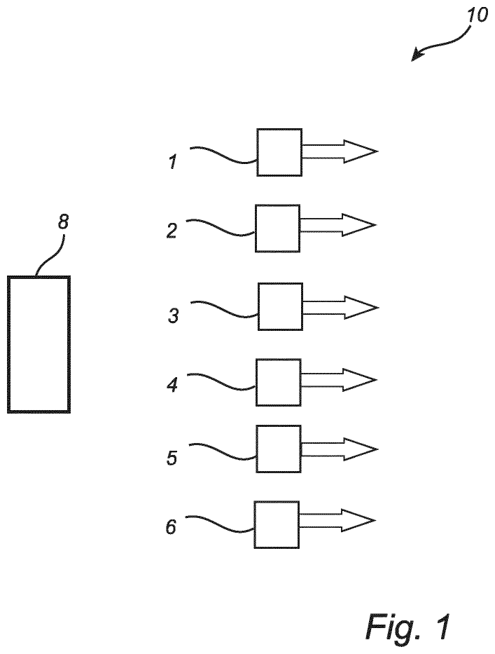

FIG. 1 is a schematic view of a system 10 according to an embodiment of the present invention.

The lighting system 10 comprises a plurality of lighting devices 1 to 6. It is to be understood that the number of lighting devices illustrated in FIG. 1 is exemplifying and that the system 10 could comprise fewer or more lighting devices than illustrated in FIG. 1. The system 10 could, in principle, comprise any number of lighting devices.

Each of the lighting devices 1-6 may be configured to emit light, schematically indicated by the arrows in FIG. 1. Each of the lighting devices 1-6 may be controllable with respect to operation thereof, for example with respect to one or more characteristics of the emitted light, such as, for example with respect to the light spectrum of the emitted light. To that end, each or any of the lighting devices 1-6 could for example comprise at least one wavelength variable light source (not shown in FIG. 1) that may be controllable at least with respect to the wavelength of the light emitted by the at least one wavelength variable light source. In alternative or in addition, each of the lighting devices 1-6 may be controllable with respect to other characteristics of the operation thereof, such as intensity of the emitted light, operating power, etc.

The system 10 comprises a controller 8, which may be configured to control operation of the respective ones of the plurality of lighting devices 1-6. Although FIG. 1 indicates a wireless connection between the controller 8 and the lighting devices 1-6, it is to be understood that the controller 8 and the lighting devices 1-6 may be connected via one or more wired connections and/or one or more wireless connections, e.g., by way of any appropriate wired and/or wireless connections as known in the art. The controller 8 may be configured to control operation of the respective ones of the lighting devices 1-6 for example by way of transmitting at least one control signal or control message or the like to the respective ones of the lighting devices 1-6.

As has been described herein, each of lighting devices 1-6 may be configured to store (and optionally obtain) data indicative of at least one of one or more natural resources usage or one or more potential environmental impacts which is caused by operations carried out in relation to the lighting device 1-6 from its manufacture and during the lifetime thereof. For each or any of the plurality of lighting devices 1-6, the data indicative of at least one of one or more natural resources usage or one or more potential environmental impacts which is caused by operations carried out in relation to the lighting device 1-6 from its manufacture and during the lifetime thereof may for example relate to at least one of manufacturing, shipping, storage, installation, use or disposal of the lighting device 1-6. As has been described herein, the data may be obtained from different entities involved in operations carried out in relation to the respective lighting devices 1-6 from their manufacture and during the lifetime thereof, such as different entities (not shown in FIG. 1) involved in the manufacturing, shipping, storage, installation, use and/or disposal of the respective lighting devices 1-6.

The controller 8 may be configured to determine, for each of the lighting devices 1-6, at least one of a measure of at least one resource usage or a measure of at least one potential environmental impact of the lighting device 1-6 derived from the stored data of the lighting device 1-6. For each lighting device 1-6, the measure of at least one potential environmental impact of the lighting device 1-6 may be derived from data indicative of one or more natural resources usage in the stored data of the lighting device 1-6 for example by means of a life cycle assessment method. The controller 8 may be configured to control operation of at least one of the plurality of lighting devices 1-6 based on the measures of the at least one resource usage and/or the measures of the at least one potential environmental impact determined for the respective ones of the lighting devices 1-6.

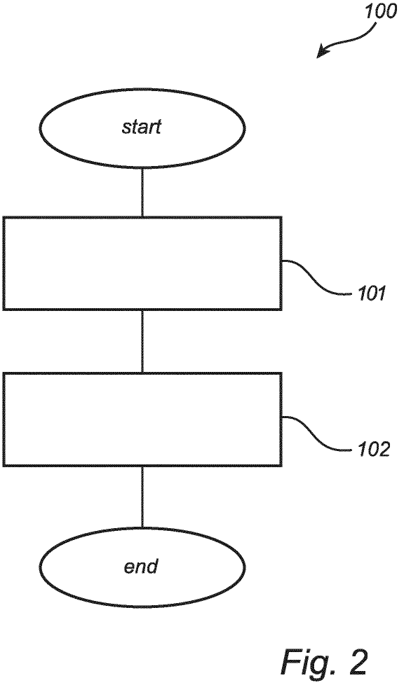

FIG. 2 is a schematic flowchart of a method 100 according to an embodiment of the present invention. The method 100 is carried out in or in relation to a system comprising a plurality of lighting devices, wherein each lighting device is configured to store data indicative of at least one of one or more natural resources usage or one or more potential environmental impacts which is caused by operations carried out in relation to the lighting device from its manufacture and during the lifetime thereof. The method 100 comprises, at 101, determining, for each of the lighting devices, at least one of a measure of at least one resource usage or a measure of at least one potential environmental impact of the lighting device derived from the stored data of the lighting device. At 102, operation of at least one of the plurality of lighting devices is controlled based on the measures of the at least one resource usage and/or the measures of the at least one potential environmental impact determined for the respective ones of the lighting devices. The method 100 may then end.

While the present invention has been illustrated in the appended drawings and the foregoing description, such illustration is to be considered illustrative or exemplifying and not restrictive; the present invention is not limited to the disclosed embodiments. Other variations to the disclosed embodiments can be understood and effected by those skilled in the art in practicing the claimed invention, from a study of the drawings, the disclosure, and the appended claims. In the appended claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope.

1. A system comprising:
a plurality of lighting devices; and
a controller configured to control operation of the respective ones of the plurality of lighting devices;
wherein each lighting device is configured to store data indicative of one or more natural resources usage, the data including an inventory table listing resource usage of the respective lighting device accumulated so far during the lifetime thereof;
wherein the controller is configured to:
obtaining the stored data for each of the lighting devices;
determine, for each of the lighting devices, a value of at least one environmental impact of the lighting device derived from the stored data of the respective lighting device by applying a transformation function to said data indicative of the one or more natural resources usage, wherein the transformation function depends on a Life Cycle Assessment (LCA) methodology; and
control operation of at least one of the plurality of lighting devices based on the value of the at least one environmental impact determined for the respective ones of the lighting devices.

2. A system according to claim 1, wherein the controller is configured to:
control the plurality of lighting devices such that any of the plurality of lighting devices having a value of the at least one environmental impact that exceeds a threshold value is not operated and such that the other one(s) of the plurality of lighting devices are operated.

3. A system according to claim 2, wherein the controller is configured to control the other one(s) of the plurality of lighting devices as a group, such that operation of each of the other one(s) of the plurality of lighting devices is controlled in the same way.

4. A system according to claim 1, wherein each lighting device is configured to, when operated, selectively provide one or more lighting functionalities, wherein the controller is configured to:
control the plurality of lighting devices such that only any of the plurality of lighting devices having a value of the at least one environmental impact that does not exceed a threshold value is operated to provide one or more of the lighting functionalities of the lighting devices.

5. A system according to claim 1, wherein each lighting device is configured to, when operated, selectively provide one or more lighting functionalities, wherein the controller is configured to:
determine an average value or a sum of the values of the at least one environmental impact determined for the respective ones of the lighting devices; and
control the plurality of lighting devices such that they are not operated, or such that one or more selected lighting functionalities of the lighting devices are prevented from being used during operation of the lighting devices, or such that one or more selected lighting functionalities of the lighting devices are degraded during operation of the lighting devices, if the average value or sum exceeds a threshold value.

6. A system according to claim 1, wherein the controller is configured to:
determine an average value or a sum of the values representative of the at least one environmental impact determined for the respective ones of the lighting devices; and
if the average value or sum does not exceed a threshold value, control the plurality of lighting devices as a group, such that operation of each of the plurality of lighting devices is controlled in the same way; and
if the average value or sum exceeds the threshold value, control the plurality of lighting devices individually and not as a group.

7. A system according to claim 1, wherein each lighting device is configured to obtain and store the data indicative of at least one of one or more natural resources usage repeatedly at different time instants, wherein the obtained data is added to any existing stored data or used to update or maintain any existing stored data.

8. The system according to claim 1, wherein the transformation function is predefined and stored in the controller.

9. The system according to claim 1, wherein said transformation function is configured to multiply the stored data indicative of one or more natural resources usage with a respective characterization factor of a Life Cycle Assessment methodology.

10. The system according to claim 1, wherein the at least one environmental impact is global warming potential or natural resource depletion.

11. The system according to claim 1, wherein each lighting device comprises a memory for locally storing said data.

12. The system according to claim wherein the plurality of lighting devices comprises a maser lighting device, wherein the master lighting device comprises the controller.

13. The system according to claim 2, wherein the controller comprises a user interface, wherein the user interface is configured to receive an user input indicating said threshold value.

14. A method in a system comprising a plurality of lighting devices, each lighting device configured to store data indicative of one or more natural resources usage, the data including an inventory table listing resource usage of the respective lighting device accumulated so far during the lifetime thereof;, the method comprising:
obtaining the stored data for each of the lighting devices;
determining, for each of the lighting devices, a value of at least one environmental impact of the lighting device derived from the stored data of the respective lighting device by applying a transformation function to said data indicative of the one or more natural resources usage; and
controlling operation of at least one of the plurality of lighting devices based on the value of the at least one environmental impact determined for the respective ones of the lighting devices.

15. A computer program product comprising instructions which, when executed by one or more processors of a controller of a system, cause the controller to carry out a method according to claim 14.
